(19) United States
(12) Patent Application Publication
(10) Pub. No.: US 2012/0229563 A1
(43) Pub. Date: Sep. 13, 2012

(54) MAINTENANCE DEVICE AND LIQUID EJECTING APPARATUS

(75) Inventor: Tomoyuki Miyazawa, Matsumoto-shi (JP)

(73) Assignee: SEIKO EPSON CORPORATION, Tokyo (JP)

(21) Appl. No.: 13/414,655

(22) Filed: Mar. 7, 2012

(30) Foreign Application Priority Data
Mar. 9, 2011 (JP) 2011-051329

(51) Int. Cl. B41J 2/165

(52) U.S. Cl. 347/30

(57) ABSTRACT

A maintenance device includes a cap that is brought into contact with a liquid ejection head on which nozzles for ejecting ink are disposed in a manner that surrounds the nozzles to form a closed space between the cap and the liquid ejection head, a separating unit that moves the cap which is in contact with the liquid ejection head away from the liquid ejection head, and a pressurizing unit that applies a pressure to the closed space before the cap is moved away from the liquid ejection head so that a pressure inside the closed space becomes higher than a pressure outside the closed space.

### BACKGROUND

1. Technical Field

The present invention relates to maintenance devices that maintain ejection properties of a liquid ejection head and liquid ejecting apparatuses having the maintenance device.

2. Related Art

As an example of liquid ejecting apparatuses, ink jet printers are widely known to perform printing by ejecting ink as a liquid onto a medium such as a sheet of paper through nozzles which are open on a nozzle forming surface of a liquid ejection head.

In order to reduce poor ejection of ink in such printers, a cap is provided to be brought into contact with the liquid ejection head (nozzles forming surface) in a manner that surrounds the nozzles for ejecting ink to form a closed space between the cap and the liquid ejection head. Then, cleaning is performed as appropriate by applying suction to the closed space by using a suction pump (suction unit) and forcibly removing the thickened ink or air bubbles from the nozzles. This cleaning process enables to maintain the ejection properties of ink ejected from the nozzles on the liquid ejection head.

In this cleaning process, if a pressure inside the closed space is a negative pressure, which is lower than a pressure of atmosphere outside the closed space, that is, an outside pressure, the negative pressure induces a pressure change by which a strong flow of the outside air may enter the cap when the cap is moved away from the liquid ejection head. This may cause, for example, the ink inside the cap or the ink adhered on the cap in the area that abuts against the liquid ejection head may be spattered (splashed) in the nozzle direction at the end of the cleaning process. In this case, the cleaning process may affect a meniscus of ink that is formed at an appropriate position inside the nozzle, which may cause so-called nozzle outs by which ink is not appropriately ejected from the nozzles may occur.

JP-A-62-273855 proposes a valve unit that opens the closed space in the cap so that the closed space communicates with the atmospheric pressure, thereby preventing a significant pressure change by reducing a pressure difference between the closed space and the atmospheric pressure when the cap is removed.

However, even if the closed space in the cap communicates with the outside air to reduce a pressure difference between the closed space and the outside pressure, a problem is found in that the outside air flows into the cap when the cap is moved away from the liquid ejection head. One of the reasons for this phenomenon seems to be that a portion of the cap undergoes deformation when abutting against the liquid ejection head, and recovers from the deformation as the cap is moved away from the liquid ejection head, thereby causing the closed space to expand, which leads to a decrease in the pressure in the closed space.

### SUMMARY

An advantage of some aspects of the invention is that a maintenance device that prevents a liquid from being spattered inside the cap when the cap is moved away from the liquid ejection head is provided. Further, an advantage of some aspects of the invention is that a liquid ejecting apparatus having the maintenance device is provided.

According to an aspect of the invention, a maintenance device includes a cap that is brought into contact with a liquid ejection head on which nozzles for ejecting a liquid are disposed in a manner that surrounds the nozzles to form a closed space between the cap and the liquid ejection head, a separating unit that moves the cap which is in contact with the liquid ejection head away from the liquid ejection head, and a pressurizing unit that applies a pressure to the closed space before the cap is moved away from the liquid ejection head so that a pressure inside the closed space becomes higher than a pressure outside the closed space.

With this configuration, since the pressure in the closed space has become a positive pressure relative to the outside of the closed space when the cap is moved away, the ink liquid inside the closed space in an area where the cap abuts against the liquid ejection head can be prevented from being spattered (splashed) inside the cap, that is, toward the nozzles. Accordingly, the meniscus of the liquid in the nozzles formed during cleaning of the liquid ejection head is maintained in a stable manner.

It is preferable that the maintenance device according to the invention further includes an outside communication unit that communicates the closed space with the air outside the closed space before the pressurizing unit applies a pressure to the closed space.

With this configuration, since the closed space in the cap communicates with the outside before a pressure is applied, the pressure in the closed space can be brought to the same value as the outside air pressure. Accordingly, when a pressure is applied to the closed space which has the same pressure as that of the outside air, the pressure in the closed space can be easily increased above the outside air pressure, that is, a positive pressure.

It is preferable that the maintenance device according to the invention further includes a suction unit that applies a suction to the closed space by means of a rotation of a driving source, wherein the pressurizing unit applies a pressure to the closed space by means of a rotation of the driving source in a direction opposite to the direction for applying a suction to the closed space.

With this configuration, the operation to apply a suction to the closed space and the operation to apply a pressure to the closed space are not performed at the same time. Accordingly, the pressure in the closed space can be increased from the negative pressure to the positive pressure by applying a pressure in a reliable manner by rotating a driving source in the opposite direction.

It is preferable that, in the maintenance device according to the invention, the suction unit is configured to apply a suction to the closed space by means of a rotation of the driving source so that a pressing rotating member rotates in one direction while pressing a tube that communicates with the cap at one end, and the pressurizing unit is configured to apply a pressure to the closed space by means of a rotation of the driving source in a direction opposite to the direction for applying a suction to the closed space, so that the pressing rotating member rotates in a direction opposite to the one direction while pressing the tube.

With this configuration, the suction unit can also be used as the pressurizing unit by reversing the rotation direction of the rotating member. Accordingly, the maintenance device can be prevented from being large-sized.

It is preferable that, in the maintenance device according to the invention, the cap forms a communication space that is formed by a wall including a movable wall which is at least partially displaceable so as to communicate with the closed space, and the pressurizing unit is configured to apply a pressure to the closed space by displacing the movable wall to reduce the volume of the communication space before the cap is moved away from the liquid ejection head.

With this configuration, since the amount of pressure applied to the closed space can be adjusted depending on the decreased amount of the volume of the communication space that communicates with the closed space, the pressure in the closed space can be easily increased to a desired pressure value.

According to an aspect of the invention, a liquid ejecting apparatus includes a liquid ejection head having nozzles that eject a liquid onto a medium, and the maintenance device having the above-mentioned maintenance device.

With this configuration, similarly to the effect of the above-mentioned maintenance device, the liquid ejecting apparatus can maintain the meniscus in the nozzles formed during cleaning of the liquid ejection head in a stable manner.

### BRIEF DESCRIPTION OF THE DRAWINGS

The invention will be described with reference to the accompanying drawings, wherein like numbers reference like elements.

FIG. 1 is a perspective view which shows a schematic configuration of a printer according to an embodiment of the invention.

FIG. 2 is a view showing a functional configuration of a maintenance device in the printer according to the embodiment.

FIG. 3 is a flow diagram of a maintenance process which shows the operation of the maintenance device according to the embodiment.

FIG. 4A is a partial sectional view of an essential portion of the maintenance device in a state where a closed space is opened to the atmosphere.

FIG. 4B is a partial sectional view of an essential portion of the maintenance device in a state where a pressure is applied to the closed space.

FIG. 4C is a partial sectional view of an essential portion of the maintenance device in a state where a cap is removed from a liquid ejection head.

FIG. 5 is a view showing a functional configuration of a maintenance device having a volume forming unit according to a modified example.

FIG. 6A is a view showing a functional configuration of the maintenance device having the volume forming unit according to the modified example in a state before the volume of the volume forming unit is decreased.

FIG. 6B is a view showing a functional configuration of the maintenance device having the volume forming unit according to the modified example in a state where the volume of the volume forming unit has been decreased.

### DESCRIPTION OF EXEMPLARY EMBODIMENTS

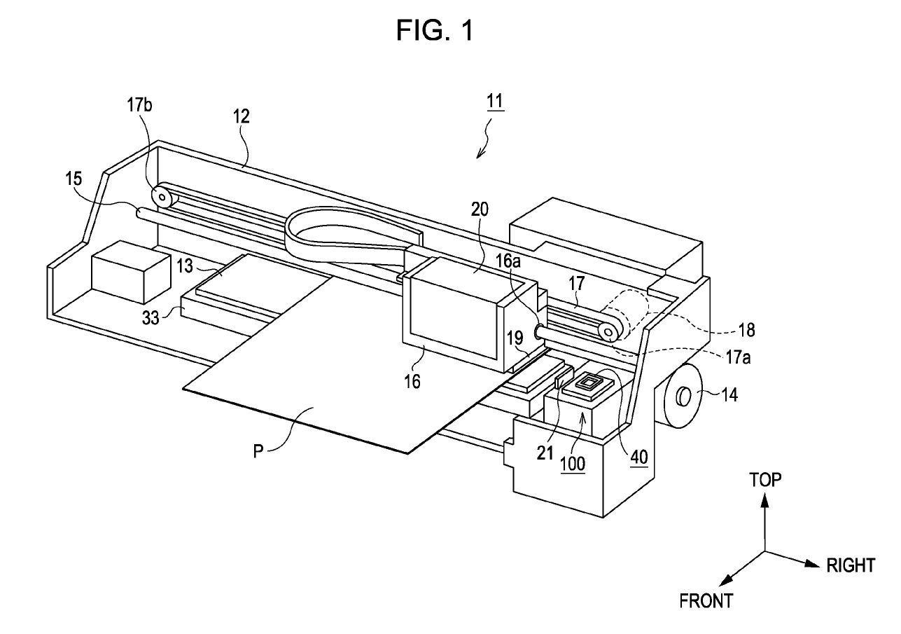

With reference to the accompanying drawings, the invention will be described below according to an embodiment which exemplifies an ink jet printer (hereinafter, also simply referred to as “printer”) as an example of liquid ejecting apparatus having a maintenance device. For simplicity of the following explanation, the gravity direction of the vertical directions shown in FIG. 1 indicates the bottom direction, and the anti-gravity direction indicates the up direction. Further, a direction perpendicular to the vertical directions is a transportation direction in which a paper sheet that has been fed to the printer is transported during printing and indicates the front direction, and a direction opposite the transportation direction indicates the back direction. Further, a direction intersecting with both the vertical directions and the transportation direction is a scan direction in which a carriage 16 reciprocates and the right and left sides of the scan direction as viewed from the front side are defined as the right and left directions, respectively.

As shown in FIG. 1, a printer 11 includes a frame 12 that is formed in a substantially rectangular box-shape in which a support table 13 is disposed in the lower portion thereof so as to extend in the longitudinal direction, which is the left-right direction. Further, a sheet feeding motor 14 is disposed on the lower side of the back of the frame 12. The sheet feeding motor 14 drives a sheet feeding mechanism, which is not shown in the figure, so that a paper sheet P as an example of medium is fed on the support table 13 from the back side.

A guide shaft 15 extends in the frame 12 above the support table 13 in the longitudinal direction of the support table 13, which is the left-right direction. The guide shaft 15 supports the carriage 16 in a manner to permit a reciprocating motion in the axis direction. More specifically, a support hole 16a extending through the carriage 16 in the left-right direction is formed such that the guide shaft 15 is inserted through the support hole 16a.

A driving pulley 17a and a driven pulley 17b are rotatably supported on the back wall of the frame 12 at positions adjacent to the both ends of the guide shaft 15. An endless timing belt 17 is wound around the driving pulley 17a and the driven pulley 17b and is partially connected to the carriage 16, while the driving pulley 17a is connected to an output shaft of the carriage motor 18. In the printer 11, the carriage 16 can be moved in a reciprocating manner in the left-right direction while being guided on the guide shaft 15 via the timing belt 17 by a drive of the carriage motor 18.

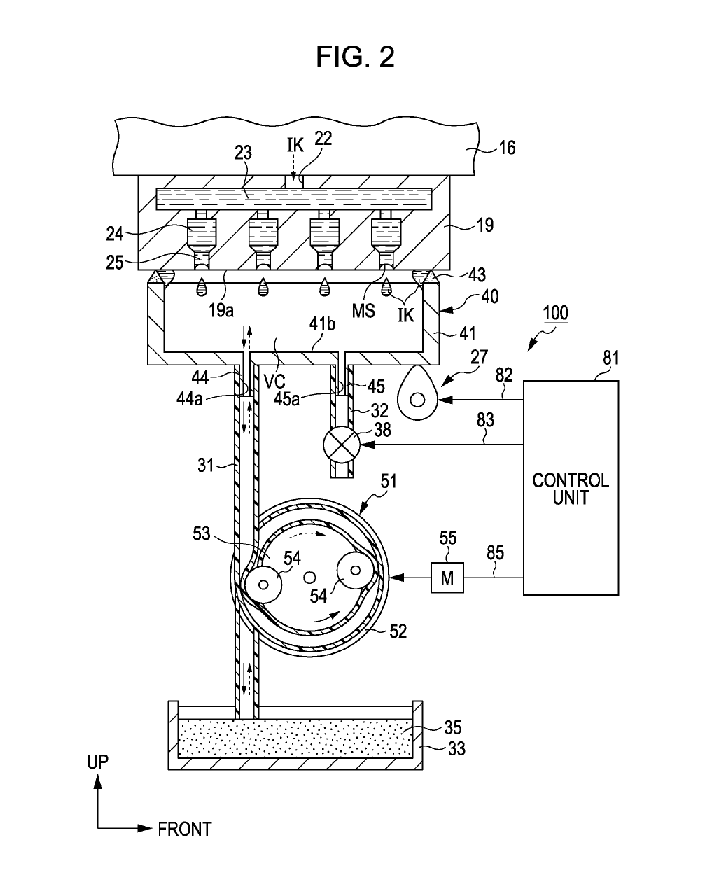

The underside of the carriage 16 is provided with a liquid ejection head 19. The liquid ejection head 19 includes a plurality of nozzles 25 for ejecting ink (see FIG. 2). Further, a nozzle formation surface 19a is disposed at the lower side of the liquid ejection head 19. The nozzle formation surface 19a has orifices for the respective nozzles 25. Moreover, an ink cartridge 20 is detachably attached to the carriage 16 so as to supply ink to the liquid ejection head 19.

In the printer 11, pressure chambers 24 (see FIG. 2) that houses, for example, piezoelectric elements are disposed in the liquid ejection head 19. When the piezoelectric elements in the pressure chambers 24 are driven, printing is performed by supplying the ink in the ink cartridge 20 to the liquid ejection head 19, and ejecting ink through the nozzles 25 (see FIG. 2) of the liquid ejection head 19 onto the paper sheet P that has been fed on the support table 13.

A maintenance device 100 that performs maintenance such as cleaning of the liquid ejection head 19 is disposed in the frame 12 in an area which is right side to the support table 13, that is, not used during printing (home position area). In the printer 11, cleaning of the liquid ejection head 19 (the nozzles 25) is performed by moving the liquid ejection head 19 to the home position area while operating the maintenance device 100 on a regular basis. This cleaning process enables to maintain the ejection properties of ink ejected from the nozzles 25, for example, by forming a stable ink meniscus MS (see FIG. 2) in the nozzles 25.

Next, a configuration of the maintenance device 100 will be briefly described below with reference to FIG. 2. As shown in FIG. 2, the maintenance device 100 includes a cap 40, a lifting device 27 as a separating unit, an air release valve 38 as an outside communication unit, and a tube pump 51 as a pressurizing unit. Although not described in this embodiment, the maintenance device 100 also includes a wiper 21 (see FIG. 1) that wipes out, for example, the waste ink adhered to the nozzle formation surface 19a, and a liquid container that receives the ink which is forcibly ejected from the nozzles as necessary.

The cap 40 includes a cap body 41 formed in a bottom-closed box-like shape, and a cap sealing unit 43 made of a material softer than that of the cap body 41 (such as rubber material and elastomer) in a rectangular shape and disposed at an upper open end of the cap body 41 which abuts against the liquid ejection head 19 (nozzle formation surface 19a). Further, an ink absorbent (not shown in the figure) made of a porous material is inserted in the cap 40 so as to absorb ink as necessary.

A projection 44 downwardly extends from a bottom wall 41b of the cap body 41 at a position close to the back side, and a discharge flow path 44a extends through the projection 44 in the up-down direction so that ink is discharged from the cap 40. The projection 44 is connected to the proximal end (upstream end) of a flexible discharge tube 31, while the other end (downstream end) of the discharge tube 31 is inserted into the waste ink tank 33 having a cuboid shape (see FIG. 1). Further, a waste ink absorbent 35 is placed in the waste ink tank 33 so as to absorb and retain the ink discharged in the waste ink tank 33.

The tube pump 51 as a suction unit is disposed in the intermediate portion of the discharge tube 31 between the cap 40 and the waste ink tank 33 so as to suction inside of the cap 40 by applying a suction from the cap 40 to the waste ink tank 33. In this embodiment, the tube pump 51 is configured to serve as a pressurizing unit that pressurize the inside of the cap 40, in addition to serve as a suction unit that suctions the inside of the cap 40.

That is, the tube pump 51 has a pump case 52 formed in a substantially cylindrical shape in which the intermediate portion of the discharge tube 31 in the length direction is placed along the inner peripheral wall of the pump case 52. Further, a rotating member 53 that is rotatable about the axis of the pump case 52 and a pair of pressing rotating members 54 that is capable of pressing against the discharge tube 31 while moving along the inner peripheral wall of the pump case 52 during rotation of the rotating member 53 are placed in the pump case 52. The rotating member 53 is driven to rotate by using a driving source such as a motor 55.

In the tube pump 51, when the rotating member 53 rotates in a counter-clockwise direction by means of a rotation drive of the motor 55 in one direction (for example, the positive direction) as indicated by the solid arrow in FIG. 2, the rotating members 54 rotate while pressing down the intermediate portion of the discharge tube 31 sequentially from the side of the cap 40 (upstream side) to the side of the waste ink tank 33 (downstream side). Then, when the rotating members 54 rotate, the air (fluid) inside the discharge tube 31 is expelled to the side of the waste ink tank 33 (downstream side), thereby decompressing the inside of the discharge tube 31 which lies on the side of the cap 40 (upstream side) with respect to the tube pump 51 and the inside of the cap 40.

Further, in the tube pump 51, when the rotating member 53 rotates in a clockwise direction by means of a rotation drive of the motor 55 in the other direction (for example, a direction opposite to the positive direction) as indicated by the dotted arrow in FIG. 2, the rotating members 54 rotate while sequentially pressing down the intermediate portion of the discharge tube 31 from the side of the waste ink tank 33 (downstream side) to the side of the cap 40 (upstream side). Then, when the rotating members 54 rotate, the air (fluid) inside the discharge tube 31 is expelled to the side of the cap 40 (upstream side), thereby pressurizing the inside of the discharge tube 31 which lies on the side of the cap 40 (upstream side) with respect to the tube pump 51 and the inside of the cap 40.

Further, a projection 45 downwardly extends from a bottom wall 41b of the cap body 41 at a position close to the front side, and an atmosphere opening path 45a extends through the projection 45 in the up-down direction so that the cap 40 is opened to the atmosphere. The projection 45 is connected to the proximal end (upstream end) of an atmosphere opening tube 32, while the other end (downstream end) of the atmosphere opening tube 32 is connected to the air release valve 38. In this embodiment, the air release valve 38 is an electromagnetic control valve, which is controlled to open and/or close based on predetermined electrical signals.

The lifting device 27 which serves as a separating unit to move the cap 40 upward and downward, for example, by rotating an eccentric cam having a cam surface on the periphery which slides against the underside of the cap 40 by using a driving source, which is not shown in the figure. That is, the cap 40 is configured to move upward toward the liquid ejection head 19 so that the cap sealing unit 43 comes into contact with the nozzle formation surface 19a, thereby forming the closed space VC between the cap 40 and the nozzle formation surface 19a. Further, the cap 40 is configured to move downward so that the cap sealing unit 43 moves away from the nozzle formation surface 19a, thereby opening the closed space VC to the atmosphere.

As shown in FIG. 2, the maintenance device 100 includes a control unit 81 that controls a drive of the lifting device 27, the air release valve 38, and the tube pump 51. The control unit 81 is electrically connected to the lifting device 27, the air release valve 38, and the motor 55 for driving the tube pump 51 so as to control the upward and downward movement of the cap 40, opening and closing of the air release valve 38, and applying suction and pressure to the tube pump 51 by sending electrical signals 82, 83, and 85, respectively. Moreover, the control unit 81 may be configured to control printing operation of the printer 11 such as driving of the sheet feeding motor 14 and the carriage motor 18.

Next, the operation of the maintenance device 100 during the cleaning process of the liquid ejection head 19 will be described below with reference to FIGS. 2, 3, 4A, 4B, and 4C. The cleaning process is performed by the control unit 81 executing procedures determined by a software or hardware.

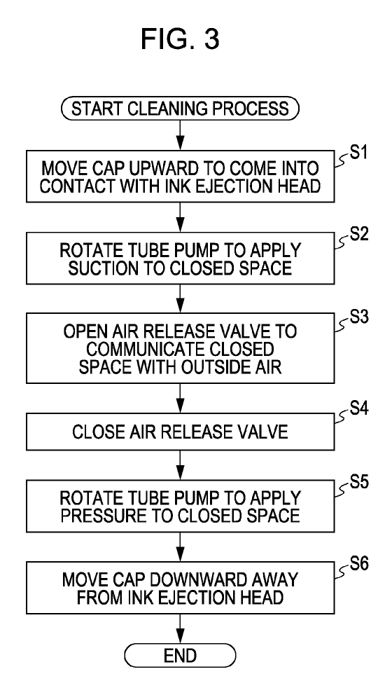

As shown in FIG. 3, when a cleaning process starts in the maintenance device 100, the cap 40 is moved upward to come into contact with the liquid ejection head 19 (step S1).

That is, the control unit 81 drives the lifting device 27 to move the cap 40 upward, as shown in FIG. 2, so that the cap sealing unit 43 comes into contact with the nozzle formation surface 19a, thereby forming the closed space VC between the cap and the nozzle formation surface 19a.

Referring back to FIG. 3, the tube pump 51 is rotated to apply a suction to the closed space VC (step S2). That is, the control unit 81 drives the motor 55 to rotate in the positive direction, thereby rotating the rotating member 54 in a direction by which the tube pump 51 serves as a suction unit, as shown by the solid arrow in FIG. 2, to apply a suction to the closed space VC. As a result, the thickened ink or air bubbles in the nozzles 25 is forcibly removed by expelling an ink IK from the nozzles 25 into the closed space VC in the cap 40, as shown in FIG. 2. As the ink IK is expelled, the ink IK is supplied from the ink cartridge 20 to an inlet port 22 of the liquid ejection head 19 to replenish the nozzles via a reservoir 23.

In some cases, when the ink IK is expelled from the nozzles 25 into the cap 40, some of the ink IK which flows along the nozzle formation surface 19a, for example, may adhere and remain near the cap sealing unit 43, as shown in FIG. 2. In addition, when the nozzle formation surface 19a is made liquid repellant against the ink IK, the ink IK tends to remain on the cap sealing unit 43.

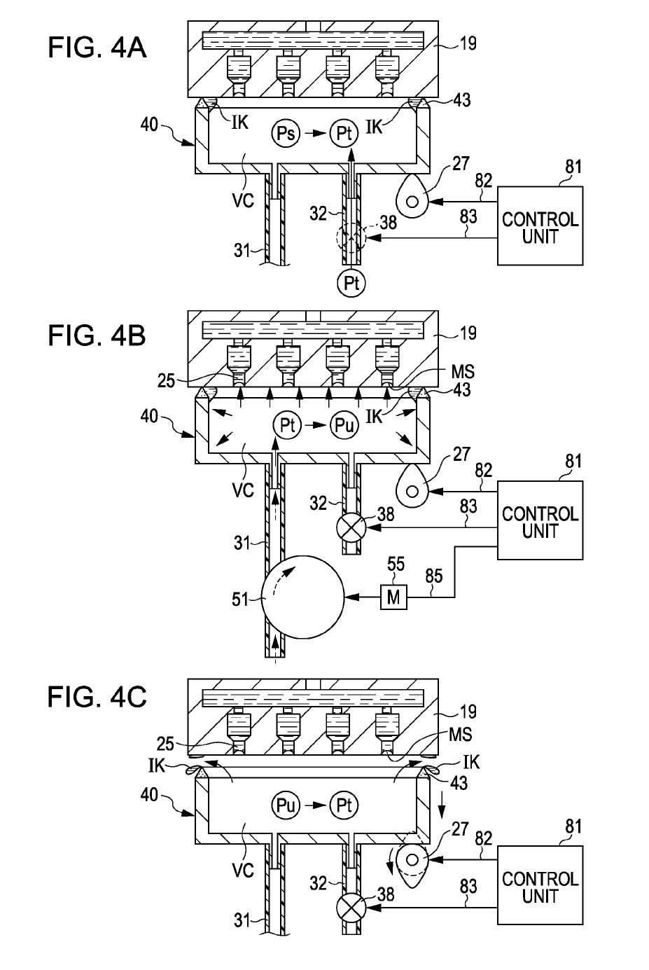

Referring back to FIG. 3, the air release valve 38 is opened to communicate the closed space VC with the outside air (step S3). That is, the control unit 81 opens the electromagnetic control valve via the electrical signals 83, thereby communicating the closed space VC with the air outside the closed space VC through the atmosphere opening tube 32 as shown in FIG. 4A. As a result, as air flows from the outside into the closed space VC which is under a decompressed pressure, the pressure in the closed space VC increases from a decompressed value Ps to an outside pressure value Pt. In this embodiment, the outside air is an open space which is exposed to the atmosphere. Accordingly, the outside pressure value Pt is approximately 1 atmosphere pressure (101.325 kPa).

Referring back to FIG. 3, the air release valve 38 is closed (step S4). That is, the control unit 81 closes the electromagnetic control valve via the electrical signals 83 when a certain time has elapsed after opening the air release valve 38, during which the pressure value in the closed space VC becomes substantially the same as the outside pressure value Pt. As a result, the pressure in the closed space VC is retained to the outside pressure value Pt.

Then, the tube pump 51 is rotated to apply a pressure to the closed space VC (step S5). That is, the control unit 81 drives the motor 55 to rotate in the opposite direction, thereby rotating (reversing) the rotating member 54 in a direction by which the tube pump 51 serves as a pressurizing unit via the electrical signals 85, as shown in FIG. 4B, to apply a pressure to the closed space VC. As a result, a specific amount of air flows into the closed space VC through the discharge tube 31. Accordingly, the pressure in the closed space VC increases from the outside pressure value Pt to a pressurized value Pu which is higher than the outside pressure value Pt.

In some cases, when air flows into the closed space VC, some of the ink IK which flows back from the waste ink tank 33 may be included in the air. Accordingly, in this embodiment, a rotation rate of the rotating member 54 (the rotating member 53), that is, an amount of air flowing into the closed space VC is determined taking into consideration such back-flow of the ink IK. In addition, the pressurized value Pu is within a range of values that allows the meniscus MS to be formed at an approximate position in the nozzles 25 in a stable manner without causing the meniscus MS to be drawn back. In this embodiment, the pressurized value Pu is approximately 15 kPa higher than 1 atmosphere pressure (101.325 kPa). At this time, the tube pump 51 is configured to rotate approximately half to one turn.

Referring back to FIG. 3, the cap 40 is moved downward away from the liquid ejection head 19 (step S6). That is, the control unit 81 drives the lifting device 27 to move the cap 40 downward, as shown in FIG. 4C, so that the cap sealing unit 43 moves away from the nozzle formation surface 19a, thereby opening the closed space VC to the atmosphere. Since the pressure in the closed space VC to be opened has been increased to the pressurized value Pu which is higher than the outside pressure value Pt, air flows out from the cap 40 to the outside, even if the volume of the closed space VC increases when the cap sealing unit 43 recovers from deformation. As a result, as shown in FIG. 4C, the ink IK which remains near the cap sealing unit 43 is blown out with the air flowing out of the cap 40 without being spattered inside the cap 40 toward the nozzles 25.

According to the above-mentioned embodiment, the following effect can be obtained:

(1) When the cap 40 moves away from the nozzle formation surface 19a, the pressure in the closed space VC is higher than the closed space VC, that is, a positive pressure. As a consequence, the ink IK inside the closed space VC in an area where the cap 40 abuts against the liquid ejection head 19 can be prevented from being spattered (splashed) inside the cap 40, that is, toward the nozzles 25. Accordingly, the meniscus MS in the nozzles 25 formed during cleaning of the liquid ejection head 19 is maintained in a stable manner.

(2) Since the closed space VC in the cap 40 communicates with the outside air before applying a pressure to the closed space VC, the pressure in the closed space VC becomes equal to the outside pressure value Pt. Accordingly, after the pressure in the closed space VC reaches the same value as the outside pressure value Pt, the pressure in the closed space VC can be easily increased above the outside pressure value Pt, that is, a positive pressure, when applying a pressure to the closed space VC.

(3) The operation to apply a suction to bring the closed space VC to be under a negative pressure and the operation to apply a pressure to bring the closed space VC to be under a positive pressure are not performed at the same time. Accordingly, the pressure in the closed space VC in the cap 40 can be increased from the negative pressure to the positive pressure by applying a pressure in a reliable manner by rotating the motor 55 in the opposite direction.

(4) The tube pump 51 can serve as both a suction unit and a pressurizing unit by switching the rotation direction of the rotating member 54. Accordingly, the maintenance device 100 can be prevented from being large-sized.

The above-mentioned embodiment may be modified as follows:

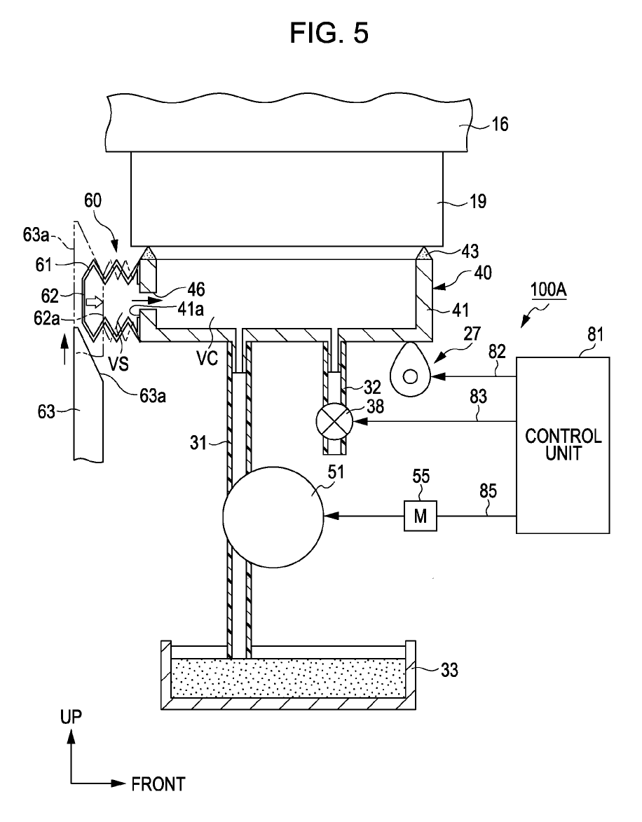

In the above-mentioned embodiment, the closed space VC in the cap 40 may be pressurized by a pressurizing unit other than the tube pump 51. This modified example will be explained with reference to FIG. 5. In this modified example, the same numbers refer to the same functions and components as those of the above-mentioned embodiment, and will not be described further in detail.

As shown in FIG. 5, a maintenance device 100A of this modified example includes a volume forming unit 60 that is disposed on a back side wall 41a of the cap body 41 so as to extend to the outside (the back side) of a cap 40 and communicate with the inside of the cap 40 through a communication hole 46.

The up, down, left and right sides and the back side of the volume forming unit 60 are defined by a wall 61 and a wall 62, respectively. Further, the front side of the volume forming unit 60 is defined by the side wall 41a of the cap body 41. The wall 61 which forms the up, down, left and right sides of the volume forming unit 60 is formed as an annular bellows that expands/collapses in the front-back direction. The bellows is configured to collapse in the front direction from the initial state, and after that, expand in the back direction to the initial state. The wall 62 vertically extends at the back end of the up, down, left and right sides of the wall 61 to form the back wall of the volume forming unit 60. Further, the front end of the wall 61 which is formed in a bellows shape is bonded to the side wall 41a of the cap body 41. As a result, the volume forming unit 60 forms a communication space VS defined by the wall 61, the wall 62, and the side wall 41a of the cap body 41, which communicates with the closed space VC.

In the volume forming unit 60, the wall 62 is provided as a movable wall that is displaceable in the front-back direction by expanding/collapsing the bellows of the wall 61 in the front-back direction. When the wall 62 is displaced forward, the volume of the communication space VS decreases. As the volume of the communication space VS decreases, air in the communication space VS, for example, flows into the closed space VC through the communication hole 46, thereby causing the pressure in the closed space VC as well as the pressure in the communication space VS to increase. That is, a pressure is applied to the closed space VC.

As shown in FIG. 5, the maintenance device 100A of this modified example includes a moving member 63 that has an inclined surface 63a on the front side of the upper end and is moved upward and downward by using a lifting mechanism (not shown in the figure) that is controlled by a control unit 81. In this modified example, the moving member 63 and the volume forming unit 60 serves as a pressurizing unit, thereby applying a pressure to the closed space VC.

That is, before the cap 40 is moved away from a liquid ejection head 19, the moving member 63 is moved upward as indicated by the double dotted line in FIG. 5, so that the inclined surface 63a at the upper end of the moving member 63 pushes the wall 62 of the volume forming unit 60 in the front direction as indicated by the reference numeral 62a in the figure. In this manner, the volume of the communication space VS in the volume forming unit 60 is decreased, thereby applying a pressure to the closed space VC to a specific pressure value (positive pressure).

According to this modified example, the following effect can be further obtained in addition to the effect of the above-mentioned embodiment (1) to (4):

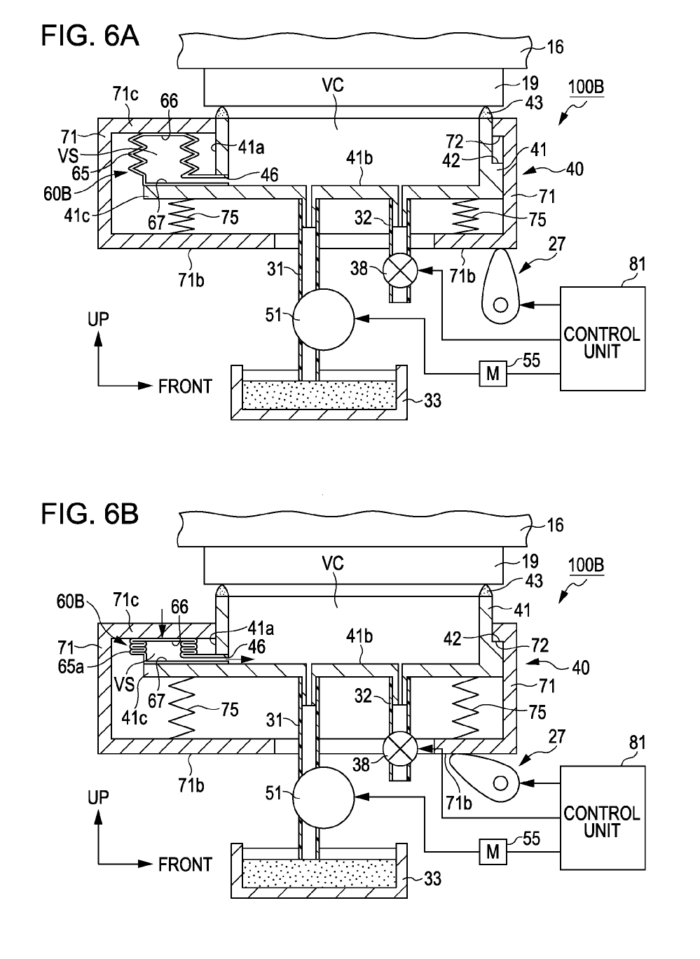

(5) Since the amount of pressure applied to the closed space VC can be adjusted depending on the decreased amount of the volume of the communication space VS that communicates with the closed space VC, the pressure in the closed space VC can be easily increased to a desired pressure value (positive pressure).
In the above-mentioned modified example, the pressurizing unit may be configured to decrease the volume of the communication space VS in accordance with the upward/downward movement of the cap 40. This modified example will be described below with reference to FIGS. 6A and 6B. In this modified example, the same numbers refer to the same functions and components as those of the above-mentioned embodiment or the above-mentioned modified example, and will not be described further in detail.

As shown in FIG. 6A, in a maintenance device 100B of this modified example, a cap 40 includes a cap body 41 and a cap holding member 71 that is formed in a substantially boxed-shape and supports the cap body 41 in a manner relatively movable in the up-down direction by using a coil spring 75. Further, a lifting device 27 is configured to move the cap 40 (a cap sealing unit 43) toward or away from a liquid ejection head 19 by moving the cap holding member 71 upward or downward.

The cap body 41 has an extension portion 41c in a plate shape that extends backward over the lower end of the side wall 41a. Further, the cap holding member 71 has an eaves-like portion 71c which is formed above the extension portion 41c so as to oppose the extension portion 41c. A volume forming unit 60B is disposed between the extension portion 41c of the cap body 41 and the eaves-like portion 71c of the cap holding member 71.

In the volume forming unit 60B of this modified example, a space having a specific amount of volume is defined by a wall 65 which forms the front, back, left and right sides thereof, and a walls 66 and 67 at the upper and lower ends of the wall 65 thereof, respectively. Further, the volume forming unit 60B has a tubular opening which extends from a position on the wall and is inserted in a sealed manner into a communication hole 46, such that the space within the volume forming unit 60B serves as a communication space VS that communicates with the closed space VC via the communication hole 46.

The wall 65 is formed as an annular bellows that expands/collapses in the up-down direction. Further, the walls 66 and 67 extend at the upper and lower ends of the wall 65, respectively, in a plane that extends in the front, back, left and right direction. The lower wall 67 abuts against the extension portion 41c of the cap body 41, and the upper wall 66 abuts against the eaves-like portion 71c of the cap holding member 71. The wall 66 serves as a movable wall that is displaceable by collapsing the bellows of the wall 65 when the eaves-like portion 71c moves downward toward the extension portion 41c and presses down the wall 66 toward the extension portion 41c.

In this modified example, the wall 66 that moves downward decreases the volume of the communication space VS. As the volume of the communication space VS decreases, air in the communication space VS, for example, flows into the closed space VC through the communication hole 46, thereby causing the pressure in the closed space VC as well as the pressure in the communication space VS to increase. Accordingly, in this modified example, the cap holding member 71 (eaves-like portion 71c) and the volume forming unit 60B serve as a pressurizing unit during the cleaning process, whose operation will be described below.

In this modified example, during the cleaning process, when the cap 40 is moved upward by the lifting device 27, the cap sealing unit 43 comes into contact with the liquid ejection head 19 as shown in FIG. 6A. That is, the coil spring 75 is compressed and the cap body 41 is lowered relative to the cap holding member 71. At this time, the bellows of the wall 65 of the volume forming unit 60B in this embodiment has expanded and the wall 66 is in contact with the eaves-like portion 71c.

Then, after a suction is applied to the closed space VC and the closed space VC is opened to the atmosphere, the cap 40 starts to be moved away from the liquid ejection head 19. At this time, in this modified example, the cap holding member 71 is lowered relative to the cap body 41, as shown in FIG. 6B. That is, the cap holding member 71 is lowered by a predetermined distance until the cap holding member 71 stops the downward movement when a stop 72 and a stop 42 formed on the front side wall of the cap holding member 71 and the cap body 41, respectively, comes into contact with each other in the up-down direction while the cap sealing unit 43 remains in contact with the liquid ejection head 19. In addition, during the downward movement of the cap holding member 71, the cap body 41 is biased toward the liquid ejection head 19 by a spring force of the coil spring 75, thereby retaining the cap sealing unit 43 to be in contact with the liquid ejection head 19.

In the maintenance device 100B of this modified example, as the cap holding member 71 is lowered by a predetermined distance, the eaves-like portion 71c presses down the wall 66 of the volume forming unit 60B, thereby compressing the bellows of the wall 65 as indicated by the reference numeral 65a in the figure. That is, in this modified example, the eaves-like portion 71c serves as a pressurizing unit. Then, before the cap 40 is moved away from the liquid ejection head 19, the communication space VS in the volume forming unit 60 decreases, thereby applying a pressure to the closed space VC to be a predetermined pressure (positive pressure).

According to this modified example, the following effect can be further obtained in addition to the effect of the above-mentioned embodiment (1) to (4) and the effect of the modified example (5):

(6) Since a pressure can be applied to the closed space VC before the cap sealing unit 43 is moved away from the liquid ejection head 19 during the downward movement of the cap 40, the pressure in the closed space VC can be increased to a positive pressure relative to the outside air with certainty before the cap 40 is moved away.
In the above-mentioned embodiment, the air release valve 38 may not necessarily be provided. For example, the control unit 81 can be configured to control rotation of the tube pump 51 (for example, rotation rate of the rotating member 53) to increase the pressure from a negative pressure to a desired positive pressure.
In the above-mentioned embodiment, the tube pump 51 may not necessarily serve as both a suction unit that applies a suction to the cap 40 and a pressurizing unit that applies a pressure to the cap 40. A tube pump solely used for the suction unit and a tube pump solely used for the pressurizing unit can be separately provided.

Further, the tube pumps can be driven by a single motor 55. In this case, the rotation direction of motor 55 may not be switched to the opposite direction. Each of the tube pump may be driven in the same direction by switching a rotation transmission path of the motor 55.
In the above-mentioned embodiment, in the case where the tube pump 51 is used as a pressurizing unit, the rotating member 54 may release pressure to the discharge tube 31 after the rotating member 53 rotates to bring the pressure in the closed space VC to a desired positive pressure.
In the above-mentioned embodiment, the pressurizing unit may be configured as a pump other than the tube pump 51. For example, a diaphragm pump, a gear pump, or a piston pump may be used.
In the above-mentioned embodiment, the pressurizing unit in combination with the tube pump 51 and the volume forming units 60 and 60B of the modified example may be configured to apply a pressure to the closed space VC. This enables to quickly increase the pressure in the closed space VC.
In the above-mentioned modified example, the walls of the volume forming units 60 and 60B may not necessarily be a bellows shape, if the walls are made of a material expandable in a planar direction, for example, a rubber material or elastomer.
Although the liquid ejecting apparatus is embodied as an ink jet printer 11 in the above embodiment, liquid ejecting apparatuses that eject or dispense liquid other than ink may be used. The invention may be applied to various liquid ejecting apparatuses having a liquid ejecting head or the like that ejects fine liquid droplets. It is noted that the liquid droplets means a state of liquid that is ejected from the liquid ejecting apparatuses and are intended to include those in a particle, tear drop or string shape. Further, the liquid as described herein may be any material that can be ejected from liquid ejecting apparatuses. For example, it may include a material in liquid phase such as liquid having high or low viscosity, sol, gel water, other inorganic solvent, organic solvent and liquid solution, and a material in melted state such as liquid resin and liquid metal (molten metal). Further, in addition to a material in a liquid state, it may include particles of functional material made of solid substance such as pigment and metal particles, which is dissolved, dispersed or mixed in a solvent. Further, typical examples of liquid include ink as mentioned above, liquid crystal and the like. The ink as described herein includes various liquid components such as general water-based ink, oil-based ink, gel ink and hot melt ink. Specific examples of liquid ejecting apparatus may include, for example, liquid ejecting apparatuses that eject liquid containing materials such as electrode material and color material in a dispersed or dissolved state, which are used for manufacturing of liquid crystal displays, EL (electroluminescence) displays, surface emitting displays or color filters, liquid ejecting apparatuses that eject bioorganic materials used for manufacturing biochips, liquid ejecting apparatuses that are used as a precision pipette and eject liquid of a sample, textile printing apparatuses and micro dispensers. Further, examples of fluid ejecting apparatus may also include liquid ejecting apparatuses that eject lubricant to precision instrument such as a clock or camera in a pinpoint manner, liquid ejecting apparatuses that eject transparent resin liquid such as ultraviolet cured resin onto a substrate for manufacturing of minute hemispheric lenses (optical lenses) used for optical communication elements or the like, and liquid ejecting apparatuses that eject acid or alkali etching liquid for etching a substrate or the like. The invention may be applied to any one of the above-mentioned liquid ejecting apparatuses.

The entire disclosure of Japanese Patent Application No. 2011-051329, filed Mar. 9, 2011 is expressly incorporated by reference herein.

What is claimed is:

1. A maintenance device comprising:
a cap that is brought into contact with a liquid ejection head on which nozzles for ejecting a liquid are disposed in a manner that surrounds the nozzles to form a closed space between the cap and the liquid ejection head;
a separating unit that moves the cap which is in contact with the liquid ejection head away from the liquid ejection head; and
a pressurizing unit that applies a pressure to the closed space before the cap is moved away from the liquid ejection head so that a pressure inside the closed space becomes higher than a pressure outside the closed space.

2. The maintenance device according to claim 1, further comprising an outside communication unit that communicates the closed space with the air outside the closed space before the pressurizing unit applies a pressure to the closed space.

3. The maintenance device according to claim 1, further comprising a suction unit that applies a suction to the closed space by means of a rotation of a driving source, wherein the pressurizing unit applies a pressure to the closed space by means of a rotation of the driving source in a direction opposite to the direction for applying a suction to the closed space.

4. The maintenance device according to claim 3, wherein
the suction unit is configured to apply a suction to the closed space by means of a rotation of the driving source so that a pressing rotating member rotates in one direction while pressing a tube that communicates with the cap at one end, and
the pressurizing unit is configured to apply a pressure to the closed space by means of a rotation of the driving source in a direction opposite to the direction for applying a suction to the closed space, so that the pressing rotating member rotates in a direction opposite to the one direction while pressing the tube.

5. The maintenance device according to claim 1, wherein
the cap forms a communication space that is formed by a wall including a movable wall which is at least partially displaceable so as to communicate with the closed space, and the pressurizing unit is configured to apply a pressure to the closed space by displacing the movable wall to reduce the volume of the communication space before the cap is moved away from the liquid ejection head.

6. A liquid ejecting apparatus comprising:
a liquid ejection head having nozzles that eject a liquid onto a medium, and
the maintenance device according to claim 1.

7. A liquid ejecting apparatus comprising:
a liquid ejection head having nozzles that eject a liquid onto a medium, and
the maintenance device according to claim 2.

8. A liquid ejecting apparatus comprising:
a liquid ejection head having nozzles that eject a liquid onto a medium, and
the maintenance device according to claim 3.

9. A liquid ejecting apparatus comprising:
a liquid ejection head having nozzles that eject a liquid onto a medium, and
the maintenance device according to claim 4.

10. A liquid ejecting apparatus comprising:
a liquid ejection head having nozzles that eject a liquid onto a medium, and
the maintenance device according to claim 5.
